(19) United States
(12) Patent Application Publication
(10) Pub. No.: US 2022/0410842 A1
(43) Pub. Date: Dec. 29, 2022

(54) SIDE DEFROSTER AIR OUTLET STRUCTURE

(71) Applicant: TOYOTA JIDOSHA KABUSHIKI KAISHA, Toyota-shi (JP)

(72) Inventor: Yu Hoshino, Toyota-shi (JP)

(73) Assignee: TOYOTA JIDOSHA KABUSHIKI KAISHA, Toyota-shi (JP)

(21) Appl. No.: 17/842,173

(22) Filed: Jun. 16, 2022

(30) Foreign Application Priority Data
Jun. 24, 2021 (JP) 2021-104905

(51) Int. Cl. B60S 1/02; B60S 1/54; B62D 25/04; B60H 1/34

(52) U.S. Cl. CPC B60S 1/023; B60S 1/54; B62D 25/04; B60H 1/3407

(57) ABSTRACT

An air outlet of a side defroster is disposed on a front pillar of a vehicle, and includes upper vertical fins configured to direct a flow of air toward a side window, and lower vertical fins configured to direct a flow of air toward a fixed window disposed forward with respect to the side window.

### CROSS REFERENCE TO RELATED APPLICATION

This application claims priority to Japanese Patent Application No. 2021-104905 filed on Jun. 24, 2021, which is incorporated herein by reference in its entirety including the specification, claims, drawings, and abstract.

### TECHNICAL FIELD

The present disclosure relates to an air outlet structure of a side defroster in a vehicle.

### BACKGROUND

Vehicles have a side defroster that defogs a side window. A side defroster blows out air from an air outlet disposed on a front pillar toward the side window to blow the air onto the side window for demisting, thereby securing the driver's visibility of a door mirror through the side window (see JP 2020-040421 A, for example).

### SUMMARY

Some vehicles further include a fixed window disposed forward with respect to the side window. Similar to the side window, the fixed window also need to be defogged to secure the driver's visibility of the door mirror.

It is difficult, however, to blow out air toward a range of area from the fixed window to the back of the side window using the air outlet disposed on the front pillar. An additional air outlet is therefore disposed on a door trim under the fixed window to demist the fixed window.

Disposing an additional air outlet for the fixed window, however, increases the costs for a side defroster. The additional air outlet further lowers design property within the vehicle cabin. This additional air outlet further requires a space for the side defroster where a duct that is connected to the additional air outlet is placed. Further, the side defroster cannot be shared between vehicles with a fixed window and vehicles without a fixed window.

An embodiment of the disclosure is therefore aimed at providing an air outlet structure of a side defroster that enables blowing of air toward both a side window and a fixed window.

In accordance with an aspect of the disclosure, an air outlet structure of a side defroster is disposed on a front pillar of a vehicle and includes a first fin configured to direct a flow of air toward a side window, and a second fin configured to direct a flow of air toward a fixed window disposed forward with respect to the side window.

In an embodiment of the side defroster air outlet structure, the first fin and the second fin may be disposed substantially vertically, and the second fin may be disposed below the first fin.

In an embodiment of the side defroster air outlet structure, the air outlet structure may further include a third fin disposed substantially horizontally to separate a first area in which a flow of air is directed by the first fin in an air outlet, from a second area in which a flow of air is directed by the second fin in an air outlet.

In an embodiment of the side defroster air outlet structure, the second fin may be inclined further outward in a vehicle width direction, relative to the first fin, as the second fin extends rearward along a vehicle length.

The air outlet structure of a side defroster of the disclosure enables blowing out of air toward both the side window and the fixed window.

This configuration eliminates the need for disposing separate air outlets for the side window and the fixed window independently, thereby reducing the costs for the defroster. As there is no need to dispose an additional air outlet for the fixed window, design property within the vehicle cabin can be increased. Further, the side defroster including no air outlet for the fixed window requires less space in the vehicle.

Also, the side defroster can be shared between vehicles with the fixed window and vehicles without the fixed window simply by modifying the fin shape of the air outlet structure.

### BRIEF DESCRIPTION OF DRAWINGS

An embodiment of the present disclosure will be described based on the following figures, wherein:

FIG. 1 is a perspective view illustrating a side defroster according to an embodiment;

FIG. 2 is a front view of an air outlet according to an example embodiment;

FIG. 3 is a cross sectional view taken along A-A line in FIG. 2 for schematically illustrating a flow of air; and

FIG. 4 is a cross sectional view taken along B-B line in FIG. 2 for schematically illustrating a flow of air.

### DESCRIPTION OF EMBODIMENTS

An example embodiment of the disclosure will be described in detail below. In the following description, specific shapes, materials, directions, numeral values, for example, are described for illustrative purposes to facilitate understanding of the disclosure, and may be changed as appropriate in accordance with the use, purpose, specification, for example.

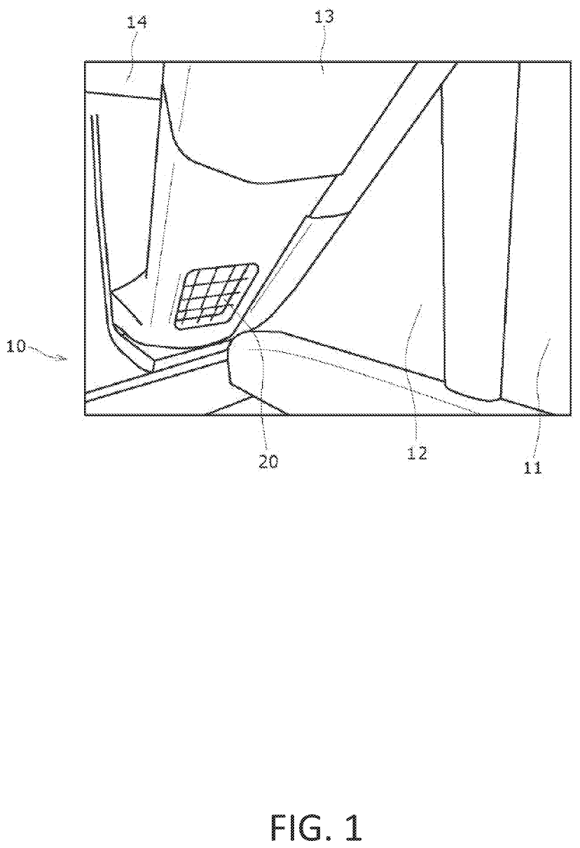

Referring to FIG. 1, a side defroster 10 according to an embodiment will be described.

The side defroster 10 is ancillary equipment for an air conditioner disposed in a vehicle. The side defroster 10 blows air on a side window 11 and a fixed window 12 to remove condensation or fogging on surfaces of the side window 11 and the fixed window 12 facing the vehicle interior. The side defroster 10 secures driver's visibility of a door mirror (not shown) through the side window 11 and the fixed window 12.

The side defroster 10 blows out the air supplied by an air conditioner (not shown) through an air outlet 20 disposed on a front pillar 13 and blows the air onto both the side window 11 and the fixed window 12.

The side window 11 and the fixed window 12 are disposed on a side face of a vehicle body. The fixed window 12 is located forward with respect to the side window 11. The side window 11 is vertically slidable by a regulator to open or close, and the fixed window 12 is fixed to the vehicle body and cannot be opened.

The front pillars 13 support the roof of the vehicle body at opposing ends of a windshield 14. The front pillar 13 houses a duct (not shown) connected to the air outlet 20.

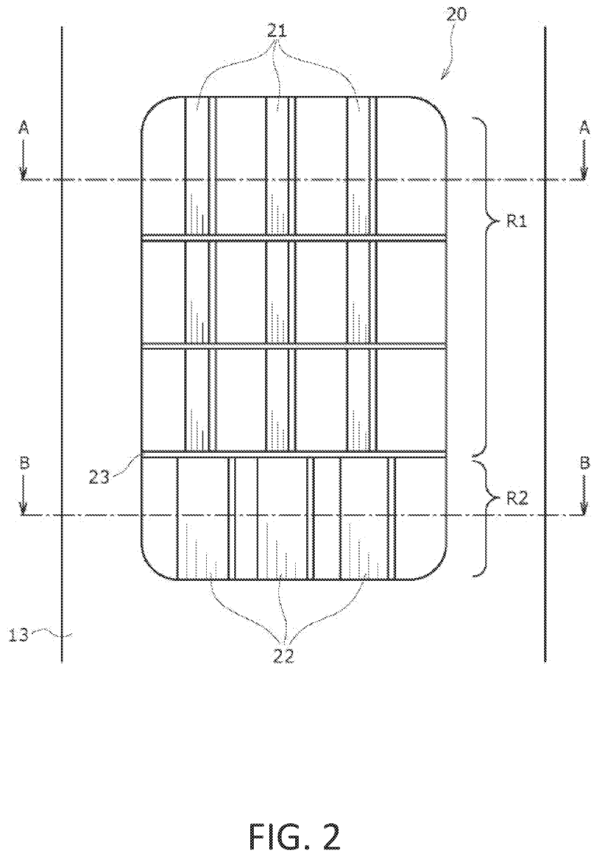

Referring to FIGS. 2 to 4, the air outlet 20 according to an example embodiment will be described.

The air outlet 20 is disposed at the lower part of the front pillar 13 and blows air, such as hot air, toward the side window 11 and the fixed window 12, as described above. Air can be blown from the air outlet 20 toward both the side window 11 and the fixed window 12, as will be detailed below.

The air outlet 20 includes a plurality of planar fins (louvers) fixed to the air outlet 20. The fins include fins (including upper vertical fins 21 and lower vertical fins 22, which will be described below) substantially parallel to the vertical direction, and a fin (including a separation fin 23 which will be described below) substantially parallel to the horizontal direction or the vehicle width direction. These fins are integrally molded from a resin material.

More specifically, the air outlet 20 includes the upper vertical fins 21 or first fins to direct a flow of air toward the side window 11, and the lower vertical fins 22 or second fins to direct a flow of air toward the fixed window 12 disposed further forward with respect to the side window 11.

The upper vertical fins 21 are disposed substantially vertically above the lower vertical fins 22. Each of the upper vertical fins 21 is disposed to be inclined outward in the vehicle width direction as the upper vertical fin 21 extends rearward along the vehicle length. The angle of inclination of the upper vertical fin 21 is determined to allow the flow of air to be directed by the upper vertical fins 21 toward the entire side window 11.

The upper vertical fins 21 are arranged parallel to each other or arranged such that a space between the upper vertical fins 21 increases toward the rear of the upper vertical fins 21. Here, an area of the air outlet 20 where the upper vertical fins 21 are disposed is referred to as an upper area R1 or a first area. The upper area R1 is formed in the upper portion of the air outlet 20.

The lower vertical fins 22 are disposed substantially vertically below the upper vertical fins 21. Each of the lower vertical fins 22 is disposed to be inclined outward in the vehicle width direction as the lower vertical fin 21 extends rearward along the vehicle length. The lower vertical fins 22 are inclined further outward relative to the upper vertical fins 21. The angle of inclination of the lower vertical fin 22 is determined to allow the flow of air to be directed by the lower vertical fins 22 toward the entire fixed window 12. The vertical length of the lower vertical fin 22 is about one-third of the vertical length of the entire upper vertical fin 21.

The lower vertical fins 22 are arranged parallel to each other or arranged such that a space between the lower vertical fins 22 increases toward the rear of the lower vertical fins 22. Here, an area of the air outlet 20 where the lower vertical fins 22 are disposed is referred to as a lower area R2 or a second area. The lower area R2 is formed in the lower portion of the air outlet 20. The lower area R2 has an area that is about one-third of the upper area R1.

The ratio of the vertical length of the upper vertical fin 21 and the vertical length of the lower vertical fin 22, that is, the ratio of the area of the upper area R1 and the area of the lower area R2, is not limited to the above example, and is determined according to the ratio of the area of the side window 11 and the area of the fixed window 12.

The air outlet 20 is disposed substantially horizontally, and further includes a separation fin 23 or a third fin that separates the upper area R1 from the lower area R2 described above. This configuration prevents mixture of the air directed by the upper vertical fins 21 with the air directed by the lower vertical fins 22.

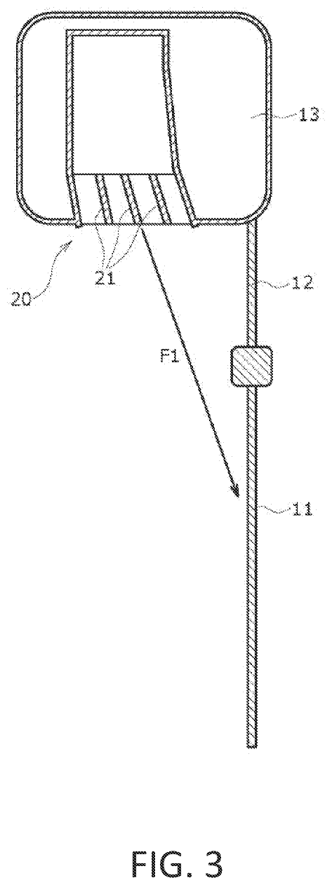

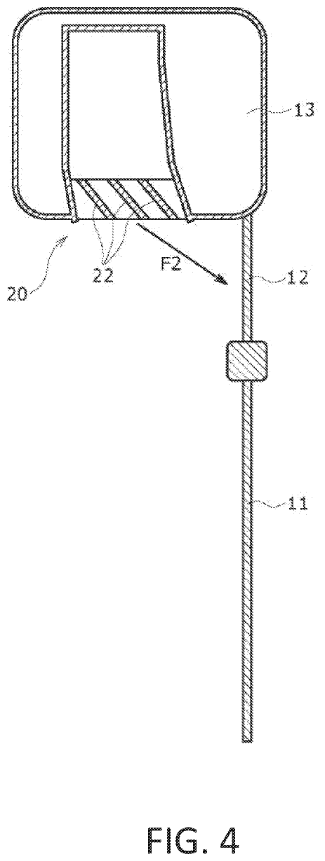

The side defroster 10 configured as described above blows air supplied from the air conditioner via the duct through the air outlet 20, for example. As illustrated in FIG. 3, the air blown out from the upper area R1 in the air outlet 20 is directed by the upper vertical fins 21 outward in the vehicle width direction and blown onto the side window 11 (see arrow F1 in FIG. 3). As illustrated in FIG. 4, the air blown out from the lower area R2 in the air outlet 20 is directed by the lower vertical fins 22 outward in the vehicle width direction and blown onto the fixed window 12 (see arrow F2 in FIG. 4).

The air outlet 20 of the side defroster 10 can thus blow out air onto both the side window 11 and the fixed window 12.

This configuration eliminates the need for disposing an air outlet for the side window 11 and an air outlet for the fixed window 12, separately, thereby reducing costs for the side defroster 10. Further, as an additional air outlet for the fixed window 12 need not be disposed on the door trim, design property within the vehicle cabin can be enhanced. Also, as an additional air outlet for the fixed window 12 need not be disposed on the door trim panel or door lining panel, a space for the side defroster 10 can be reduced within the vehicle.

The side defroster 10 can be shared between vehicles with the fixed window 12 and vehicles without the fixed window 12 simply by changing the shape of fins in the air outlet structure.

As described above, the upper vertical fins 21 for directing the flow of air toward the side window 11 are disposed in the upper portion of the air outlet 20 and the lower vertical fins 22 for directing the flow of air toward the fixed window 12 are disposed in the lower portion of the air outlet 20. This configuration enables air to be reliably blown onto the lower portion of the fixed window 12 disposed close to the air outlet 20 or disposed further frontward.

When the fins for directing the flow of air toward the side window 11 are disposed in the lower portion of the air outlet 20 and the fins for directing the flow of air toward the fixed window 12 are disposed in the upper portion of the air outlet 20, for example, it is not possible to blow sufficient air from the upper portion of the air outlet 20 toward the lower portion of the fixed window 12.

In the above example, the fins for directing the flow of air toward the side window 11 or the upper vertical fins 21, and the fins for directing the flow of air toward the fixed window 12 or the lower vertical fins 22, are arranged separately along the vertical direction. This configuration reduces the pressure loss in the air outlet 20.

When the fins for directing the flow of air toward the side window 11 are disposed inward along the vehicle width, and the fins for directing the flow of air toward the fixed window 12 are disposed outward along the vehicle width, for example, it is necessary to increase the bending angle, using the fins, to blow the air onto the fixed window 12. This configuration increases the pressure loss.

The present disclosure is not limited to the embodiment described above and modification examples thereof, and various modifications and improvements, may be made within the scope of the features as defined in the claims of the present application.

1. A side defroster air outlet structure disposed on a front pillar of a vehicle, the side defroster air outlet structure comprising:
a first fin configured to direct a flow of air toward a side window; and
a second fin configured to direct a flow of air toward a fixed window disposed forward with respect to the side window.

2. The side defroster air outlet structure according to claim 1, wherein
the first fin and the second fin are disposed substantially vertically, and
the second fin is disposed below the first fin.

3. The side defroster air outlet structure according to claim 1, further comprising:
a third fin disposed substantially horizontally to separate a first area in which a flow of air is directed by the first fin in an air outlet, from a second area in which a flow of air is directed by the second fin in the air outlet.

4. The side defroster air outlet structure according to claim 1, wherein
the second fin is inclined further outward in a vehicle width direction, relative to the first fin, as the second fin extends rearward along a vehicle length.

5. The side defroster air outlet structure according to claim 2, further comprising:
a third fin disposed substantially horizontally to separate a first area in which a flow of air is directed by the first fin in the air outlet, from a second area in which a flow of air is directed by the second fin in the air outlet.

6. The side defroster air outlet structure according to claim 2, wherein
the second fin is inclined further outward in a vehicle width direction, relative to the first fin, as the second fin extends rearward along a vehicle length.

7. The side defroster air outlet structure according to claim 3, wherein,
the second fin is inclined further outward in a vehicle width direction, relative to the first fin, as the second fin extends rearward along a vehicle length.
